(19) United States
(12) Patent Application Publication
(10) Pub. No.: US 2022/0263298 A1
(43) Pub. Date: Aug. 18, 2022

(54) WIRING MEMBER

(71) Applicants: AutoNetworks Technologies, Ltd., Mie (JP); Sumitomo Wiring Systems, Ltd., Mie (JP)

(72) Inventors: Tetsuya NISHIMURA, Mie (JP); Daisuke EBATA, Mie (JP); Masaki MIZUSHITA, Mie (JP); Taku UMEHARA, Mie (JP); Hidetoshi ISHIDA, Mie (JP); Ryusuke KUDO, Mie (JP); Haruka NAKANO, Mie (JP); Kenta ARAI, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 17/611,009

(22) PCT Filed: May 26, 2020
(86) PCT No.: PCT/JP2020/020710

§ 371 Date: Nov. 12, 2021

(30) Foreign Application Priority Data
May 31, 2019 (JP) 2019-103110
Sep. 11, 2019 (JP) 2019-165359

(51) Int. Cl. H02G 3/04; H01B 7/08; H01B 7/36; B60R 16/02

(52) U.S. Cl. CPC H02G 3/0406; B60R 16/0215; H01B 7/36; H01B 7/08

(57) ABSTRACT

A wiring member includes a plurality of wire-like transmission members. The plurality of wire-like transmission members are grouped into at least a plurality of first wire-like transmission members and a plurality of second wire-like transmission members in accordance with a predetermined condition regarding the plurality of wire-like transmission members. The wiring member includes a first flat wiring member including the plurality of first wire-like transmission members a second flat wiring member including the plurality of second wire-like transmission members. At least a part of the first flat wiring member and at least a part of the second flat wiring member are stacked.

### TECHNICAL FIELD

The present disclosure relates to a wiring member.

### BACKGROUND ART

Patent Document 1 describes a technique relating to a flat wiring member.

### PRIOR ART DOCUMENTS

### Patent Documents

Patent Document 1: Japanese Patent Application Laid-Open No. 2018-137208

### SUMMARY

### Problem to be Solved by the Invention

When a large number of wirings are needed, a plurality flat wiring members are considered to be stacked. In this case, it is desired that a plurality of stacked flat wiring members are manufactured easily.

Accordingly, an object is to provide a technique capable of manufacturing a plurality of stacked flat wiring members easily.

### Means to Solve the Problem

A wiring member according to the present disclosure is a wiring member including a plurality of wire-like transmission members, wherein the plurality of wire-like transmission members are grouped into at least a plurality of first wire-like transmission members and a plurality of second wire-like transmission members in accordance with a predetermined condition regarding the plurality of wire-like transmission members, the wiring member includes: a first flat wiring member including the plurality of first wire-like transmission members; and a second flat wiring member including the plurality of second wire-like transmission members, and at least a part of the first flat wiring member and at least a part of the second flat wiring member are stacked.

### Effects of the Invention

According to the present disclosure, a wiring member including stacked first and second flat wiring members is manufactured easily.

### BRIEF DESCRIPTION OF DRAWINGS

FIG. 1 is a plan view illustrating an example of a wiring member according to an embodiment.

FIG. 2 is a cross-sectional view illustrating an example of the wiring member according to the embodiment.

FIG. 3 is a cross-sectional view illustrating an example of the wiring member according to the embodiment.

FIG. 4 is a cross-sectional view illustrating an example of the wiring member according to the embodiment.

FIG. 5 is a cross-sectional view illustrating an example of the wiring member according to the embodiment.

FIG. 6 is a plan view illustrating an example of the wiring member according to the embodiment.

FIG. 7 is a plan view illustrating an example of the wiring member according to the embodiment.

FIG. 8 is a plan view illustrating an example of the wiring member according to the embodiment.

FIG. 9 is a drawing for describing an example of a color of a wire-like transmission member according to the embodiment.

FIG. 10 is a drawing for describing an example of a color of a wire-like transmission member according to the embodiment.

FIG. 11 is a plan view illustrating an example of a flat wiring member according to the embodiment.

FIG. 12 is a plan view illustrating an example of the flat wiring member according to the embodiment.

FIG. 13 is a plan view illustrating an example of the flat wiring member according to the embodiment.

FIG. 14 is a plan view illustrating an example of the flat wiring member according to the embodiment.

FIG. 15 is a cross-sectional view illustrating an example of the wiring member according to the embodiment.

FIG. 16 is a side view illustrating an example of the wiring member according to the embodiment.

### DESCRIPTION OF EMBODIMENT(S)

### Description of Embodiment of Present Disclosure

Embodiments of the present disclosure are listed and described firstly.

A wiring member according to the present disclosure is as follows.

(1) A wiring member includes a plurality of wire-like transmission members, wherein the plurality of wire-like transmission members are grouped into at least a plurality of first wire-like transmission members and a plurality of second wire-like transmission members in accordance with a predetermined condition regarding the plurality of wire-like transmission members, the wiring member includes: a first flat wiring member including the plurality of first wire-like transmission members; and a second flat wiring member including the plurality of second wire-like transmission members, and at least a part of the first flat wiring member and at least a part of the second flat wiring member are stacked. According to the present disclosure, the plurality of wire-like transmission members in the same group are included in the same flat wiring member, thus the wiring member including the stacked first and second flat wiring members can be manufactured easily.

(2) The plurality of wire-like transmission members may be grouped into at least the plurality of first wire-like transmission members and the plurality of second wire-like transmission members in accordance with a connection destination of the plurality of wire-like transmission members. In this case, the stacked first and second flat wiring members are routed easily.

(3) The plurality of wire-like transmission members may be grouped into at least the plurality of first wire-like transmission members and the plurality of second wire-like transmission members in accordance with a type of the plurality of wire-like transmission members. In this case, the same type of wire-like transmission member can be included in the same flat wiring member, thus the wiring member including the stacked first and second flat wiring members is manufactured easily.

(4) It is applicable that the plurality of first wire-like transmission members include a power source line or a ground line, and the plurality of second wire-like transmission members include a signal line. In this case, the signal line is included in the flat wiring member different from that of the power source line or the ground line in which a relatively large amount of current flows, thus the signal line is hardly influenced by the power source line or the ground line. As a result, noise hardly occurs in the signal line.

(5) It is applicable that the plurality of first wire-like transmission members are connected to at least one standard mounted component of a vehicle, and the plurality of second wire-like transmission members are connected to at least one optional component of the vehicle. In this case, the optional component is connected to the wire-like transmission member included in the flat wiring member different from that to which the standard mounted component is connected, thus the wiring member can be easily compatible with presence or absence of the optional component in manufacturing the wiring member. Thus, the wiring member can be manufactured easily.

(6) It is applicable that the plurality of first wire-like transmission members are connected to at least one first connection target part located in a first area, and the plurality of second wire-like transmission members are connected to at least one second connection target part located in a second area different from the first area. In this case, the wire-like transmission members of the first and second flat wiring members are connected to the connection target parts located in the area different from each other, thus the stacked first and second flat wiring members are routed easily.

(7) The plurality of first wire-like transmission members may include at least one wire-like transmission member indicating a color capable of distinguishing the first flat wiring member and the second flat wiring member. In this case, the first flat wiring member and the second flat wiring member can be distinguished, thus an accurate stacking can be performed in a process of stacking the first and second flat wiring members.

(8) The plurality of first wire-like transmission members may include at least one wire-like transmission member indicating a color different from a color of at least one of the plurality of second wire-like transmission members. In this case, the first flat wiring member and the second flat wiring member can be distinguished easily, thus an accurate stacking can be performed in a process of stacking the first and second flat wiring members.

(9) The plurality of first wire-like transmission members may include at least one wire-like transmission member indicating a color different from a color of each of the plurality of second wire-like transmission members. In this case, the first flat wiring member and the second flat wiring member can be further distinguished easily, thus an accurate stacking can be performed in a process of stacking the first and second flat wiring members.

(10) The first flat wiring member includes a bending part where a plurality of third wire-like transmission members included in the plurality of first wire-like transmission members are bended, and a third wire-like transmission member with a smallest diameter in the plurality of third wire-like transmission members is located on an innermost side of the bending part. In this case, a bending radius of a third wire-like transmission member with a larger outer diameter than the third wire-like transmission member with the smallest diameter can be increased in the bending part. Thus, the third wire-like transmission member with the large diameter can be bended easily.

(11) The plurality of third wire-like transmission members are disposed to be located on an outer side as a diameter of each of the plurality of third wire-like transmission members gets larger in the bending part. In this case, the bending radius of the third wire-like transmission member can be increased as the diameter of the third wire-like transmission member gets larger. Thus, the plurality of third wire-like transmission members can be bended easily.

### Details of Embodiment of Present Disclosure

Specific examples of a wiring member of the present disclosure are described hereinafter with reference to the drawings. The present invention is not limited to these examples, but is indicated by claims, and it is intended that meanings equivalent to claims and all modifications within a scope of claims are included.

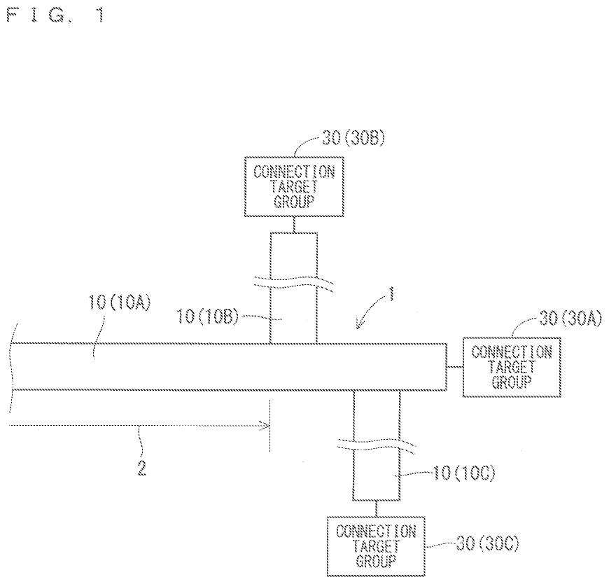

A wiring member according to an embodiment is described hereinafter. FIG. 1 is a schematic plan view illustrating a wiring member 1. The wiring member 1 includes a plurality of stacked flat wiring members 10. The plurality of flat wiring members 10 are members connecting a plurality of components mounted to a vehicle of an automobile, for example. In the present example, the wiring member 1 includes stacked three flat wiring members 10A, 10B, and 10C. The number of the plurality of stacked flat wiring members 10 included in the wiring member 1 may be two, or four or more flat wiring members 10 may also be provided. At least one of the plurality of flat wiring members 10 included in the wiring member 1 may be branched or bended. In the example in FIG. 1, each of the flat wiring members 10B and 10C is bended.

The wiring member 1 includes a stacked part 2 in which the flat wiring members 10A, 10B, and 10C are stacked. In the stacked part 2, at least a part of the flat wiring member 10A, at least a part of the flat wiring member 10B, and at least a part of the flat wiring member 10C are stacked. In the stacked part 2 in the present example, a part of the flat wiring member 10A, a part of the flat wiring member 10B, and a part of the flat wiring member 10C are stacked.

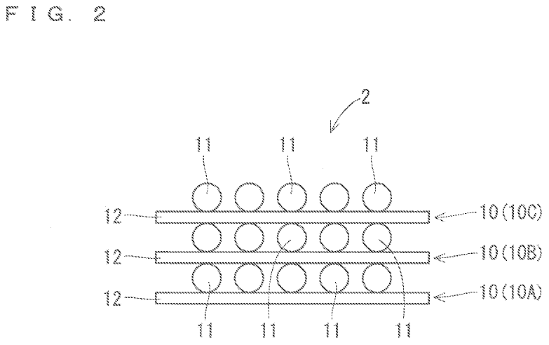

FIG. 2 is a schematic cross-sectional view of the stacking part 2. Each flat wiring member 10 includes a plurality of wire-like transmission members 11 and a sheet 12. The wire-like transmission member 11 is a wire-like member transmitting an electrical power or light, for example. In the present example, the wire-like transmission member 11 is an electrical wire including a core wire and an insulating covering for covering the core wire. The core wire is a wire-like conductor formed by a metal conductive member, for example. The core wire is made up of one or a plurality of strands. The insulating covering is an insulating part covering around the core wire. The wire-like transmission member 11 may be a bare conductive wire, a shielded wire, a twisted wire, an enamel wire, a nichrome wire, or an optical fiber, for example, in addition to the electrical wire. In the example in FIG. 2, a diameter of each of the plurality of wire-like transmission members 11 is the same as each other.

The sheet 12 is a sheet-like member keeping the plurality of wire-like transmission members 11 in a flat form. The sheet 12 is formed of resin, for example. The sheet 12 may include metal. The sheet 12 may include a non-woven sheet. The plurality of wire-like transmission members 11 are fixed to one main surface of the sheet 12 in a parallel state. The wire-like transmission member 11 is fixed to the sheet 12 by welding, bonding, or adhesion, for example. The welding may be ultrasonic welding or thermal welding. The plurality of wire-like transmission members 11 are fixed to one main surface of the sheet 12, thereby being kept in a flat state.

The example of the flat wiring member 10 is not limited to the above example. The plurality of wire-like transmission members 11 may be kept in a flat state by a flat frame member, for example. The plurality of wire-like transmission members 11 may be directly joined in parallel to be in a flat form. The flat wiring member 10 may be kept in a flat state so that a plurality of wire-like conductors are insulated from each other by an insulating member such as a flexible flat cable (FFC) and a flexible printed circuit (EPC), for example. That is to say, the flat wiring member 10 may be a wiring member in which a plurality of wire-like conductors are held in a flat form in a state of being insulated from each other and formed so that a thickness thereof is smaller than a width thereof as a whole.

In the stacking part 2, as illustrated in FIG. 2, the flat wiring members 10A, 10B, and 10C are stacked in this order. The plurality or wire-like transmission members 11 of the flat wiring member 10A and the sheet 12 of the flat wiring member 10B overlap with each other, and the plurality of wire-like transmission member 11 of the flat wiring member 10B and the sheet 12 of the flat wiring member 10C overlap with each other.

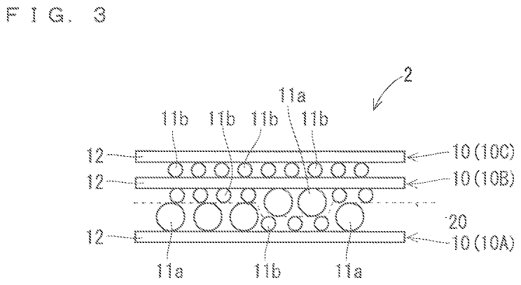

The flat wiring member 10 may include the plurality of wire-like transmission members 11 each having a diameter different from each other. In the example in FIG. 3, the flat wiring members 10A and 10B include a wire-like transmission member 11a having a relatively large diameter and a wire-like transmission member 11b having a relatively small diameter, respectively. The flat wiring member 10C does not include the wire-like transmission member 11a having the relatively large diameter but includes the wire-like transmission member 11b having the relatively small diameter. Described in the example in FIG. 3 are the plurality of wire-like transmission members 11 with two types of diameter included in the flat wiring member 10, however, three types of diameter are also applicable.

In the stacked two flat wiring members 10, the plurality of wire-like transmission members 11 of one flat wiring member 10 and the plurality of wire-like transmission members 11 of the other flat wiring member 10 may overlap with each other. In the example in FIG. 3, the plurality of wire-like transmission members 11 of the flat wiring member 11A and the plurality of wire-like transmission members 11 of the flat wiring member 10B overlap with each other.

In the example in FIG. 2, a boundary line between the stacked two flat wiring members 10 forms a straight line in a cross-sectional view of the stacking part 2, but may form a bending line. FIGS. 3 to 5 are drawings each illustrating an example of a cross-sectional structure of the stacking part 2 in a case where the boundary line between the stacked two flat wiring members 10 are bended.

In the example in FIG. 3, a concave space occurs in the flat wiring member 10A by the wire-like transmission member 11b with the small diameter included in the flat wiring member 10A. A protruding part occurs in the flat wiring member 10B by the wire-like transmission member 11a with the large diameter included in the flat wiring member 10B. The protruding part of the flat wiring member 10B is disposed in the concave space of the flat wiring member 10A. Accordingly, a boundary line 20 between the stacked two flat wiring members 10A and 10B is not straight but is bended.

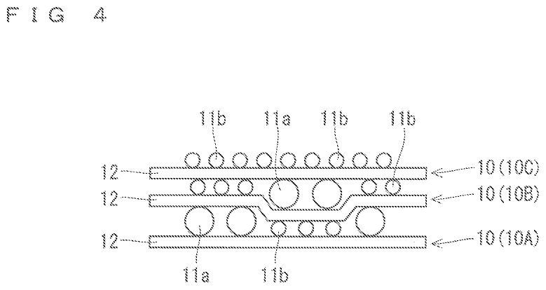

In the example in FIG. 4, the sheet 12 can be flexibly deformed, and the sheet 12 of the flat wiring member 10B is deformed in accordance with the concave space generated by the wire-like transmission member 11b with the small diameter included in the flat wiring member 10A. Accordingly, the boundary line between the stacked two flat wiring members 10A and 10B is not straight but is bended.

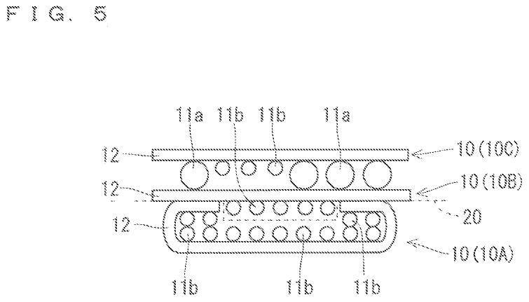

In the example in FIG. 5, the plurality of wire-like transmission members 11b included in the flat wiring member 10B are disposed in the concave space generated by bending, in the same direction, both end portions of the flat wiring member 10A in a width direction, thus the boundary line 20 is bended.

The stacking part 2 may include the whole flat wiring member 10A. That is to say, in the stacked part 2, the whole flat wiring member 10A, at least a part of the flat wiring member 10B, and at least a part of the flat wiring member 10C may be stacked. The stacking part 2 may include the whole flat wiring member 10B or the whole flat wiring member 10C. The stacking part 2 may include a bending portion.

The flat wiring member 10 may include a connector connected to at least one end of at least one of the plurality of wire-like transmission members 11 included in the flat wiring member 10. The wiring member 1 may include a stacked connector. In this case, the stacked connector may include a connector to which at least one wire-like transmission member 11 of the flat wiring member 10A is connected, a connector to which at least one wire-like transmission member 11 of the flat wiring member 10B is connected, and a connector to which at least one wire-like transmission member 11 of the flat wiring member 10C is connected.

A structure of keeping the plurality of flat wiring members 10 in a stacked state in the stacking part 2 is not particularly limited. For example, a configuration of winding a banding member such as an adhesive tape around the stacking part 2 may be adopted. The plurality of flat wiring members 10 may be bonded by an adhesive agent or a double-sided tape, for example, intervening therebetween. A configuration of bonding the sheets 12 on both side portions of the plurality of flat wiring members 10 by welding, an adhesive tape, or an adhesive agent or a configuration of keeping the sheets 12 in an overlapping state by a clamp, for example, may also be adopted.

Herein, the plurality of wire-like transmission members 11 included in the wiring member 1 are divided into a plurality of groups in accordance with a predetermined condition regarding the plurality of wire-like transmission members 11. In the present example, the plurality of wire-like transmission members 11 included in the wiring member 1 are divided into a first group including the plurality of wire-like transmission members 11, a second group including the plurality of wire-like transmission members 11, and a third group including the plurality of wire-like transmission members 11. The flat wiring member 10A includes the plurality of wire-like transmission members 11 of the first group, the flat wiring member 10B includes the plurality of wire-like transmission members 11 of the second group, and the flat wiring member 10C includes the plurality of wire-like transmission members 11 of the third group. The plurality of wire-like transmission members 11 included in the wiring member 11 may be divided into two groups or four or more groups.

As described above, in the present example, the plurality of wire-like transmission members 11 of the same group are included in the same flat wiring member 10 with regard to the stacked plurality of flat wiring members 10. Accordingly, the wiring member 1 including the plurality of stacked flat wiring members 10 is manufactured easily.

The plurality of wire-like transmission members 11 included in the wiring member 1 are divided into the first group, the second group, and the third group in accordance with a connection destination of the plurality of wire-like transmission members 11, for example. Described hereinafter is an example of the connection destination of each flat wiring member 10 in a case where the plurality of wire-like transmission members 11 included in the wiring member 1 are divided into groups in accordance with the connection destination.

The wiring member 1 is connected to a plurality of connection target parts in a vehicle, for example. The plurality of connection target parts to which the wiring member 1 is connected are divided into a plurality of connection target groups 30. The plurality of connection target groups 30 include a connection target group 30A including at least one connection target part, a connection target group 30B including at least one connection target part, and a connection target group 30C including at least one connection target part (refer to FIG. 1).

The plurality of wire-like transmission members 11 included in the wiring member 1 is divided into the first group including the plurality of wire-like transmission members 11 connected to the connection target part of the connection target group 30A, the second group including the plurality of wire-like transmission members 11 connected to the connection target part of the connection target group 30B, and the third group including the plurality of wire-like transmission members 11 connected to the connection target part of the connection target group 30C. Accordingly, the flat wiring member 10A includes the plurality of wire-like transmission members 11 connected to the connection target part of the connection target group 30A, the flat wiring member 10B includes the plurality of wire-like transmission members 11 connected to the connection target part of the connection target group 30B, and the flat wiring member 10C includes the plurality of wire-like transmission members 11 connected to the connection target part of the connection target group 30C.

One end of the plurality of wire-like transmission members 11 included in the flat wiring member 10A is connected to at least one connection target part included in the connection target group 30A. One end of the plurality of wire-like transmission member 11 included in the flat wiring member 10B is connected to at least one connection target part included in the connection target group 30B. One end of the plurality of wire-like transmission members 11 included in the flat wiring member 10C is connected to at least one connection target part included in the connection target group 30C. The number of the plurality of connection target groups 30 may be two, or four or more connection target groups 30 may also be applicable.

As described above, in the present example, the plurality of stacked flat wiring members 10 are connected to the plurality of connection target groups 30 different from each other. That is to say, the plurality of wire-like transmission members 11 included in the flat wiring member 10 can be connected to the connection target part of the same connection target group 30 for each of the plurality of stacked flat wiring members 10. Accordingly, each of the plurality of stacked flat wiring members 10 is routed easily. An example of grouping the plurality of connection target parts is described hereinafter.

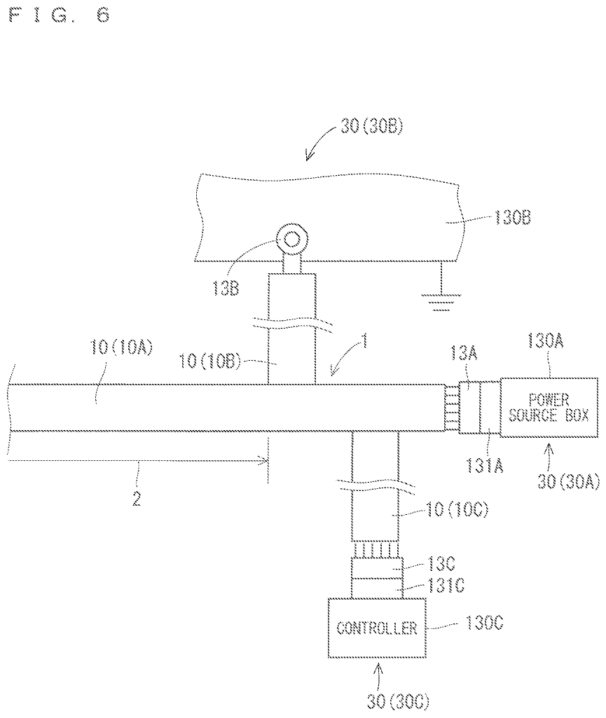

FIG. 6 is a drawing for describing an example of grouping. In the example in FIG. 6, the connection target group 30A includes a connection target part outputting a power source of a circuit mounted to a vehicle. For example, the connection target group 30A includes a power source box 130A. In the present example, each wire-like transmission member 11 of the flat wiring member 10A is a power source line.

The connection target group 30B includes a connection target part for grounding each wire-like transmission member 11 of the flat wiring member 10B. For example, the connection target group 30B includes a grounded metal body 130B. In the present example, each wire-like transmission member 11 of the flat wiring member 10A is a ground line.

The connection target group 30C includes a connection target part performing at least one of output or input of a signal. For example, the connection target group 30C includes a controller 130C. In the present example, each wire-like transmission member 11 of the flat wiring member 10C is a signal line. The controller 130C includes an electronic control unit (ECU), for example.

One end of the plurality of wire-like transmission members 11 of the flat wiring member 10A is connected to the power source box 130A. In the present example, a connector 13A is connected to one end of the plurality of wire-like transmission members 11 of the flat wiring member 10A. The connector 13A is connected to a connector 131A included in the power source box 130A. Accordingly, a power source outputted from the power source box 130A is given to each wire-like transmission member 11 of the flat wiring member 10A.

One end of the plurality of wire-like transmission members 11 of the flat wiring member 10B is connected to the metal body 130B. In the present example, a ground terminal 13B is connected to one end of the plurality of wire-like transmission members 11 of the flat wiring member 10B. The ground terminal 13B is fixed to the metal body 130B with a screw, for example. Accordingly, each wire-like transmission member 11 of the flat wiring member 10B is grounded.

One end of the plurality of wire-like transmission members 11 of the flat wiring member 10C is connected to the controller 130C. In the present example, a connector 13C is connected to one end of the plurality of wire-like transmission members 11 of the flat wiring member 10C. The connector 13C is connected to a connector 131C included in the controller 130C. When the connector 131C includes an output terminal, a signal outputted from the controller 130C (for example, a control signal for controlling a circuit) is given to the wire-like transmission member 11 of the flat wiring member 10C. When the connector 131C includes an input terminal, a signal which the wire-like transmission member 11 of the flat wiring member 10C transmits (for example, a detection signal of a sensor) is inputted to the controller 130C.

The connection target group may include a plurality of connection target parts. In this case, a plurality of connection target parts located in positions close to each other may be included in the connection target group.

For example, the connection target group 30A may include a plurality of power source boxes 130A. In this case, it is applicable that the plurality of wire-like transmission members 11 of the flat wiring member 10A are branched into a plurality of branch parts, and the plurality of branch parts are connected to the plurality of power source boxes 130A, respectively. The connection target part outputting the power source included in the connection target group 30A may be other than the power source box 130A.

The connection target group 30B may include a plurality of grounded connection target parts. In this case, it is applicable that the plurality of wire-like transmission members 11 of the flat wiring member 10B are branched into a plurality of branch parts, and the plurality of branch parts are connected to a plurality of grounded connection target parts, respectively.

The connection target group 30C may include a plurality of controllers. In this case, it is applicable that the plurality of wire-like transmission members 11 of the flat wiring member 10C are branched into a plurality of branch parts, and the plurality of branch parts are connected to the plurality of controllers, respectively. The connection target group 30C may include a member other than the controller. For example, the connection target group 30C may include at least one sensor outputting a signal.

In the wiring member 1 according to the example in FIG. 6, the signal line is included in the flat wiring member 10 different from that including the power source line in which a relatively large amount of current flows. Accordingly, the signal line is hardly influenced by the power source line. Thus, noise hardly occurs in the signal line.

In the example in FIG. 6, the signal line is included in the flat wiring member 10 different from that including the ground line in which a relatively large amount of current flows. Accordingly, the signal line is hardly influenced by the ground line. Thus, noise hardly occurs in the signal line.

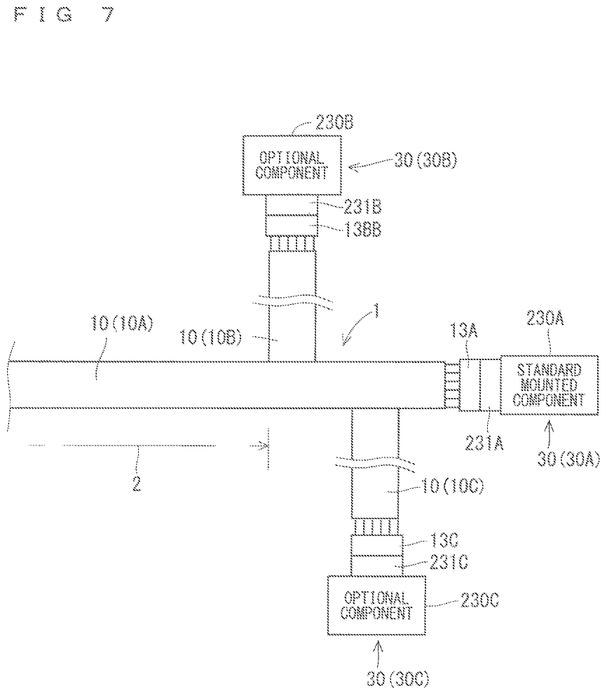

FIG. 7 is a drawing for describing the other example of grouping. In the example in FIG. 7, the connection target group 30A includes a standard mounted component 230A of a vehicle. The standard mounted component 230A is an apparatus such as a room lamp, a hazard lamp, a digital meter indicating a speed, an air conditioner, or an air bag mechanism, for example.

The connection target group 30B includes an optional component 230B of a vehicle. Herein, the optional component includes not only an apparatus mounted to a vehicle in addition to the standard mounted component but also an apparatus mounted in place of the standard mounted component. The optional component is also referred to as an optional apparatus. Considered as the apparatus mounted to the vehicle in addition to the standard mounted component is a fog lamp, a drive recorder, an electronic toll collection system (ETC) in-vehicle apparatus, or a back monitor camera, for example. Considered as the apparatus mounted in place of the standard mounted component is a car navigation apparatus providing higher performance than a car navigation apparatus which is standardly mounted, an audio apparatus providing higher performance than an audio apparatus which is standardly mounted, or a light emitting diode (LED) head light mounted in place of a halogen head light which is standardly mounted, for example. The optional component 230B may be an apparatus mounted to a vehicle in addition to the standard mounted component or an apparatus mounted in place of the standard mounted component.

The connection target group 30C includes an optional component 230C different from the optional component 230B. The optional component 230C may be an apparatus mounted to a vehicle in addition to the standard mounted component or an apparatus mounted in place of the standard mounted component. A type of the standard mounted component and the optional component of the vehicle changes in accordance with a type and a grade of the vehicle, for example.

One end of the plurality of wire-like transmission members 11 of the flat wiring member 10A is connected to the standard mounted component 230A. In the present example, the connector 13A is connected to one end of the plurality of wire-like transmission members 11 of the flat wiring member 10A. The connector 13A is connected to a connector 231A included in the standard mounted component 230A.

One end of the plurality of wire-like transmission members 11 of the flat wiring member 10B is connected to the optional component 230B. In the present example, a connector 13BB is connected to one end of the plurality of wire-like transmission members 11 of the flat wiring member 10B. The connector 13BB is connected to a connector 231B included in the optional component 230B.

One end of the plurality of wire-like transmission members 11 of the flat wiring member 10C is connected to the optional component 230C. In the present example, a connector 13C is connected to one end of the plurality of wire-like transmission members 11 of the flat wiring member 10C. The connector 13C is connected to a connector 231C included in the optional component 230C.

The connection target group 30 may include a plurality of standard mounted components. In this case, a plurality of standard mounted components located in positions close to each other may be included in the connection target group 30. The connection target group 30 may include a plurality of optional components. In this case, a plurality of optional components located in positions close to each other may be included in the connection target group 30.

For example, the connection target group 30A may include a plurality of connection mounted components. In this case, it is applicable that the plurality of wire-like transmission members 11 of the flat wiring member 10A are branched into a plurality of branch parts, and the plurality of branch parts are connected to the plurality of standard mounted components, respectively. In the similar manner, the connection target group 30B may include a plurality of optional components, and the connection target group 30C may include a plurality of optional components.

In the wiring member 1 according to the example in FIG. 7, the optional component is connected to the wire-like transmission member 11 of the flat wiring member 10 different from that to which the standard mounted component is connected. Accordingly, the wiring member 1 can be easily compatible with presence or absence of the optional component in manufacturing the wiring member 1. Thus, the wiring member 1 can be easily manufactured. For example, when the optional component 230C is not mounted, the wiring member 1 can be easily compatible with presence or absence of the optional component 230C by not mounting the flat wiring member 10C to the wiring member 1.

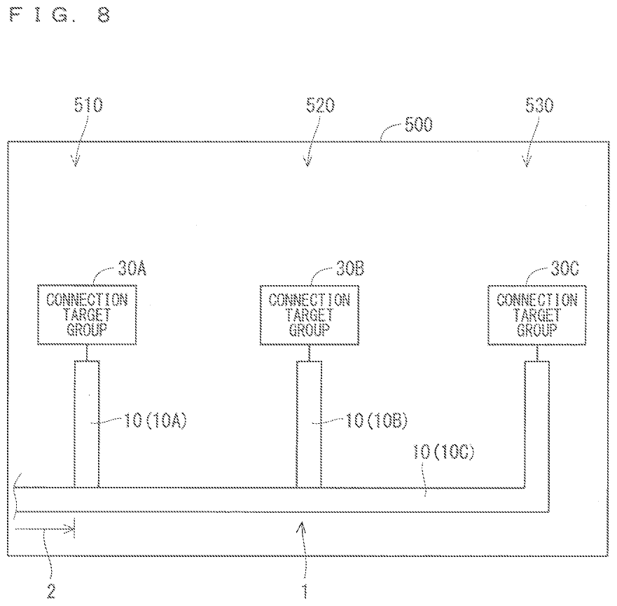

FIG. 8 is a drawing for describing the other example of grouping. FIG. 8 illustrates the wiring member 1 routed on a roof 500 of a vehicle. In the example in FIG. 8, the plurality of connection target parts are divided into groups in accordance with an area where the connection target part is located.

The connection target part included in the connection target group 30A is located in a front area 510 of the roof 500. The connection target group 30A includes a room lamp located in the front area 510 of the roof 500, for example. One end of the plurality of wire-like transmission members 11 of the flat wiring member 10A is connected to the room lamp located in the front area 510. One end of the plurality of wire-like transmission members 11 of the flat wiring member 10A may be connected to the plurality of connection target parts located in the front area 510.

The connection target part included in the connection target group 30B is located in a center area 520 of the roof 500. The connection target group 30B includes a room lamp located in the center area 520 of the roof 500, for example. One end of the plurality of wire-like transmission members 11 of the flat wiring member 10B is connected to the room lamp located in the center area 520. One end of the plurality of wire-like transmission members 11 of the flat wiring member 10B may be connected to the plurality of connection target parts located in the center area 520.

The connection target part included in the connection target group 30C is located in a back area 530 of the roof 500. The connection target group 30C includes an antenna located in the back area 530 of the roof 500, for example. One end of the plurality of wire-like transmission members 11 of the flat wiring member 10C is connected to the antenna located in the back area 530. One end of the plurality of wire-like transmission members 11 of the flat wiring member 10C may be connected to the plurality of connection target parts located in the back area 530.

The position of the connection target part included in the connection target group 30 is not limited to the example described above. For example, the connection target part included in the connection target group 30A may be located in an installment panel in front of the vehicle. The connection target part included in the connection target group 30A may be located in a panel on a back of the vehicle.

In the wiring member 1 according to the example in FIG. 8, the wire-like transmission members 11 of the plurality of flat wiring members 10 are connected to the connection target parts located in the areas different from each other, thus the plurality of stacked flat wiring members 10 can be routed easily.

In the example described above, the plurality of wire-like transmission members 11 included in the wiring member 11 are divided into the plurality of groups in accordance with the connection destination, but may be divided into the plurality of groups in accordance with the other condition. For example, the plurality of wire-like transmission members 11 included in the wiring member 1 may be divided into the plurality of groups in accordance with a type of the plurality of wire-like transmission members 11. Accordingly, the same type of the plurality of wire-like transmission members 11 can be included in the same flat wiring member 10. Thus, the wiring member 1 including the plurality of stacked flat wiring members 10 is manufactured easily. A plurality of examples in this case are described hereinafter.

The plurality of wire-like transmission members 11 included in the wiring member 1 may be divided into the plurality of groups in accordance with a diameter of the wire-like transmission member 11, for example. For example, the plurality of wire-like transmission members 11 included in the wiring member 1 are divided into a first group including the plurality of wire-like transmission members 11 each having a large diameter, a second group including the plurality of wire-like transmission members 11 each having a medium diameter, and a third group including the plurality of wire-like transmission members 11 each having a small diameter. In this case, the plurality of wire-like transmission members 11 with the large diameter included in the first group are included in the flat wiring member 10A. The plurality of wire-like transmission members 11 with the medium diameter included in the second group are included in the flat wiring member 10B. The plurality of wire-like transmission members 11 with the small diameter included in the third group are included in the flat wiring member 10C.

The plurality of wire-like transmission members 11 included in the wiring member 1 may be divided into the plurality of groups in accordance with a material of core wires of the wire-like transmission members 11. In this case, the plurality of groups may include a first group including the plurality of wire-like transmission members 11 whose core wires are made of aluminum and a second group including the plurality of wire-like transmission members 11 whose core wires are made of copper. A third group may include a plurality of wire-like transmission members 11 whose core wires have the same diameter, for example.

The plurality of wire-like transmission members 11 included in the wiring member 1 may be divided into the plurality of groups in accordance with a shape of core wires of the wire-like transmission members 11. In this case, the plurality of groups may include a first group including the plurality of wire-like transmission members 11 whose core wires are strands and a second group including the plurality of wire-like transmission members 11 whose core wires are single wires. A third group may include a plurality of wire-like transmission members 11 whose core wires have the same diameter, for example.

The plurality of wire-like transmission members 11 included in the wiring member 1 may be divided into the plurality of groups in accordance with a compression ratio of metal constituting the core wires of the wire-like transmission members 11. For example, the plurality of wire-like transmission members 11 included in the wiring member 1 are divided into a first group including the plurality of wire-like transmission members 11 with metal constituting the core wires having a large compression ratio, a second group including the plurality of wire-like transmission members 11 with metal constituting the core wires having a medium degree of compression ratio, and a third group including the plurality of wire-like transmission members 11 with metal constituting the core wires having a small compression ratio.

When the plurality of wire-like transmission members 11 included in the wiring member 1 are divided into the plurality of groups in accordance with a type of the wire-like transmission members 11, the plurality of connection target parts to which the wiring member 1 is connected needs not be divided into the plurality of connection target groups 30.

<Color Indicated by Wire-Like Transmission Member>

Described next is a color indicated by the wire-like transmission member 11 included in the flat wiring member 10, that is to say, a color of an outer peripheral surface of the wire-like transmission member 11. In the present example, the wire-like transmission member 11 is the electrical wire including the core wire and the insulating covering for covering the core wire, thus it can be deemed that the color indicated by the wire-like transmission member 11 is the color of the outer peripheral surface of the insulating covering for covering the core wire.

The color indicated by each of the plurality of wire-like transmission members 11 included in the flat wiring member 10 may be the same as each other. In this case, the color indicated by the wire-like transmission member 11 may be the same as or different from each other between the plurality of flat wiring members 10. In the former case, the color indicated by all of the wire-like transmission members 11 included in the wiring member 1 is the same as each other. In this case, the color indicated by each wire-like transmission member 11 included in the wiring member 1 may be black or the other color.

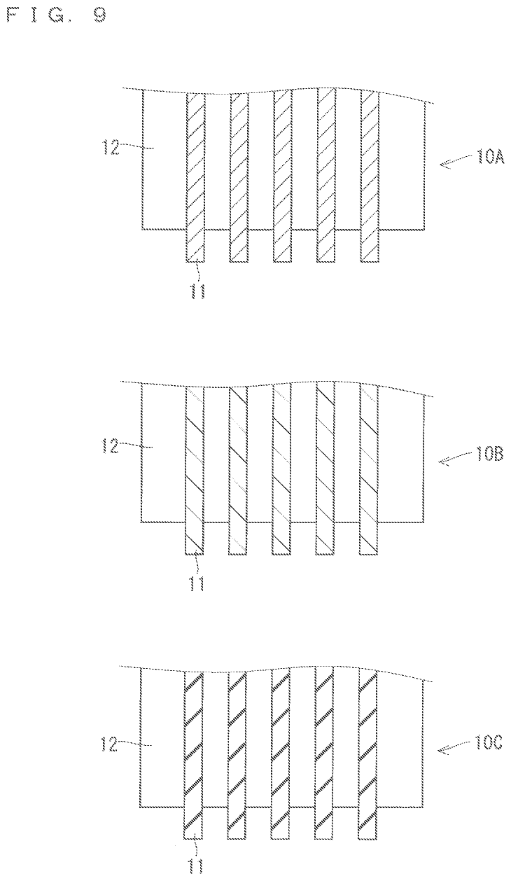

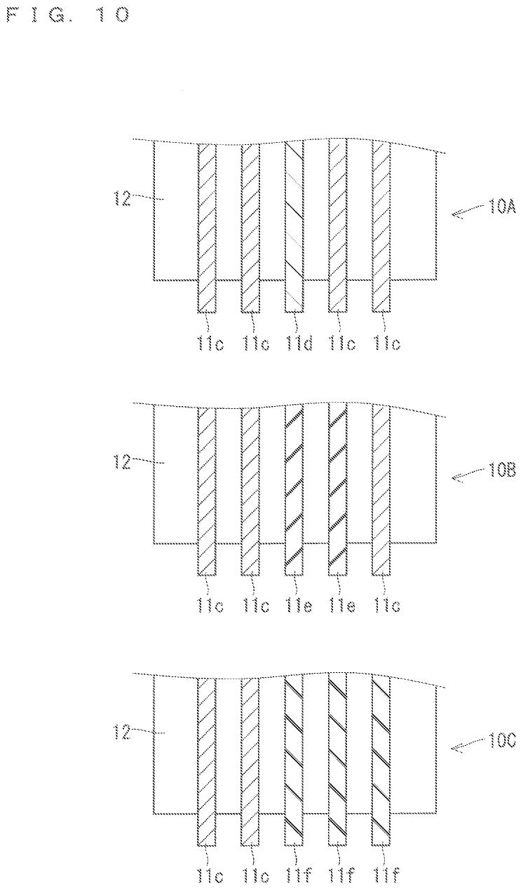

FIG. 9 is a drawing for describing an example of the color indicated by the wire-like transmission member 11. In FIG. 9 and FIG. 10 described hereinafter, the flat wiring members 10A, 10B, and 10C are not stacked but illustrated separately from each other for explanatory convenience. In FIG. 9 and FIG. 10 hereinafter, the same hatching is assigned to the plurality wire-like transmission members 11 indicating the same color, and different hatching are assigned to the plurality of wire-like transmission members 11 indicating different colors.

In the example in FIG. 9, the color indicated by the plurality of wire-like transmission members 11 of the flat wiring member 10A is the same as each other. The color indicated by the plurality of wire-like transmission members 11 of the flat wiring member 10B is the same as each other. The color indicated by the plurality of wire-like transmission members 11 of the flat wiring member 10C is the same as each other. In the meanwhile, the color indicated by the wire-like transmission member 11 is different from each other between the plurality of flat wiring members 10A, 10B, and 10C. The color indicated by each wire-like transmission member 11 of the flat wiring member 10A is black, for example. The color indicated by each wire-like transmission member 11 of the flat wiring member 10B is red, for example. The color indicated by each wire-like transmission member 11 of the flat wiring member 10C is blue, for example.

Herein, an attention is focused on the flat wiring member 10A. In the example in FIG. 9, the plurality of wire-like transmission members 11 of the flat wiring member 10A include the wire-like transmission member 11 indicating a color different from those of the plurality of wire-like transmission members 11 of the flat wiring member 10B. Accordingly, the flat wiring member 10A can be distinguished from the flat wiring member 10B. Accordingly, the plurality of wire-like transmission members 11 of the flat wiring member 10A are deemed to include the wire-like transmission members 11 indicating the color capable of distinguishing the flat wiring member 10A and the flat wiring member 10B. The plurality of wire-like transmission members 11 of the flat wiring member 10A include the wire-like transmission member 11 indicating the color different from those of the plurality of wire-like transmission members 11 of the flat wiring member 10C. Accordingly, the flat wiring member 10A can be distinguished from the flat wiring member 10C. Accordingly, the plurality of wire-like transmission members 11 of the flat wiring member 10A are deemed to include the wire-like transmission members 11 indicating the color capable of distinguishing the flat wiring member 10A and the flat wiring member 10C.

In the similar manner, when an attention is focused on the flat wiring member 10B, the plurality of wire-like transmission members 11 of the flat wiring member 10B are deemed to include the wire-like transmission members 11 indicating the color capable of distinguishing the flat wiring member 10B and the flat wiring member 10A. The plurality of wire-like transmission members 11 of the flat wiring member 10B are deemed to include the wire-like transmission members 11 indicating the color capable of distinguishing the flat wiring member 10B and the flat wiring member 10C.

In the similar manner, when an attention is focused on the flat wiring member 10C, the plurality of wire-like transmission members 11 of the flat wiring member 10C are deemed to include the wire-like transmission members 11 indicating the color capable of distinguishing the flat wiring member 10C and the flat wiring member 10A. The plurality of wire-like transmission members 11 of the flat wiring member 10C are deemed to include the wire-like transmission members 11 indicating the color capable of distinguishing the flat wiring member 10C and the flat wiring member 10B.

FIG. 10 is a drawing for describing the other example of the color indicated by the wire-like transmission member 11. In the example in FIG. 10, each of the plurality of flat wiring members 10A, 10B, and 10C includes a wire-like transmission member 11c indicating a common color between the plurality of flat wiring members 10A, 10B, and 10C. The color indicated by the wire-like transmission member 11c is black, for example.

Each of the plurality of flat wiring members 10A, 10B, and 10C includes the wire-like transmission member 11 indicating a color different from that of each wire-like transmission member 11 included in the other flat wiring member 10.

The flat wiring member 10A includes one wire-like transmission member 11d indicating a color different from that of each wire-like transmission member 11 included in the flat wiring member 10B and that of each wire-like transmission member 11 included in the flat wiring member 10C. The color indicated by the wire-like transmission member 11d is red, for example. The flat wiring member 10A may include two or more wire-like transmission members 11d.

The flat wiring member 10B includes two wire-like transmission members 11e indicating a color different from that of each wire-like transmission member 11 included in the flat wiring member 10A and that of each wire-like transmission member 11 included in the flat wiring member 10C. The color indicated by the wire-like transmission member 11e is blue, for example. The flat wiring member 10B may include one wire-like transmission member 11e or three or more wire-like transmission members 11e.

The flat wiring member 10C includes three wire-like transmission members 11f indicating a color different from that of each wire-like transmission member 11 included in the flat wiring member 10A and that of each wire-like transmission member 11 included in the flat wiring member 10B. The color indicated by the wire-like transmission member 11f is yellow, for example. The flat wiring member 10B may include two or less wire-like transmission member 11f or four or more wire-like transmission members 11f.

Herein, an attention is focused on the flat wiring member 10A. In the example in FIG. 10, the plurality of wire-like transmission members 11 of the flat wiring member 10A include the wire-like transmission member 11d indicating the color different from that of the wire-like transmission member 11e of the flat wiring member 10B. Accordingly, the flat wiring member 10A can be distinguished from the flat wiring member 10B. Accordingly, the plurality of wire-like transmission members 11 of the flat wiring member 10A are deemed to include the wire-like transmission members 11d indicating the color capable of distinguishing the flat wiring member 10A and the flat wiring member 10B. The plurality of wire-like transmission members 11 of the flat wiring member 10A include the wire-like transmission member 11d indicating the color different from that of the wire-like transmission member 11f of the flat wiring member 10C. Accordingly, the flat wiring member 10A can be distinguished from the flat wiring member 10C. Accordingly, the plurality of wire-like transmission members 11 of the flat wiring member 1A are deemed to include the wire-like transmission members 11d indicating the color capable of distinguishing the flat wiring member 10A and the flat wiring member 10C.

In the similar manner, when an attention is focused on the flat wiring member 10B, in the example in FIG. 10, the plurality of wire-like transmission members 11 of the flat wiring member 10B are deemed to include the wire-like transmission members 11e indicating the color capable of distinguishing the flat wiring member 10B and the flat wiring member 10A. The plurality of wire-like transmission members 11 of the flat wiring member 10B are deemed to include the wire-like transmission members 11e indicating the color capable of distinguishing the flat wiring member 10B and the flat wiring member 10C.

In the similar manner, when an attention is focused on the flat wiring member 10C, in the example in FIG. 10, the plurality of wire-like transmission members 11 of the flat wiring member 10C are deemed to include the wire-like transmission members 11f indicating the color capable of distinguishing the flat wiring member 10C and the flat wiring member 10A. The plurality of wire-like transmission members 11 of the flat wiring member 10C are deemed to include the wire-like transmission member 11 indicating the color capable of distinguishing the flat wiring member 10C and the flat wiring member 10B.

When an attention is focused on the distinction of the flat wiring member 10A and the flat wiring member 10B, in the example in FIG. 10, all of the wire-like transmission members 11 included in one of the flat wiring member 10A and the flat wiring member 10B may have the same color. In the similar manner, when an attention is focused on the distinction of the flat wiring member 10A and the flat wiring member 10C, all of the wire-like transmission members 11 included in one of the flat wiring member 10A and the flat wiring member 10C may have the same color. In the similar manner, when an attention is focused on the distinction of the flat wiring member 10B and the flat wiring member 10C, all of the wire-like transmission members 11 included in one of the flat wiring member 10B and the flat wiring member 10C may have the same color.

As described above, in the example in FIG. 9 and FIG. 10, the plurality of wire-like transmission members 11 of one flat wiring member 10 in the stacked two flat wiring members 10 include at least one wire-like transmission member 11 indicating the color capable of distinguishing the one flat wiring member 10 and the other flat wiring member 10. Accordingly, the two flat wiring members can be distinguished. As a result, the plurality of flat wiring members can be accurately stacked in a process of stacking the plurality of flat wiring members 10. For example, it is suppressed to stack the plurality of flat wiring members 10 in a wrong order or mistake the types of the plurality of stacked flat wiring members 10.

As with the example described above, when the plurality of wire-like transmission members 11 of one flat wiring member 10 in the stacked two flat wiring members 10 include at least one wire-like transmission member indicating the color different from that of at least one of the plurality of wire-like transmission members 11 of the other flat wiring member 10, the two flat wiring members 10 can be distinguished easily. Thus, the plurality of flat wiring members can be accurately stacked in a process of stacking the plurality of flat wiring members 10.

As with the example described above, when the plurality of wire-like transmission members 11 of one flat wiring member 10 in the stacked two flat wiring members 10 include at least one wire-like transmission member 11 indicating the color different from that of each of the plurality of wire-like transmission members 11 of the other flat wiring member 10, the two flat wiring members 10 can be further distinguished easily. Thus, the plurality of flat wiring members can be accurately stacked in a process of stacking the plurality of flat wiring members 10.

A specific example of the color indicated by the wire-like transmission member 11 included in the flat wiring member 10 is not limited to the above example.

<Arrangement of Plurality of Wire-Like Transmission Members in Flat Wiring Member>

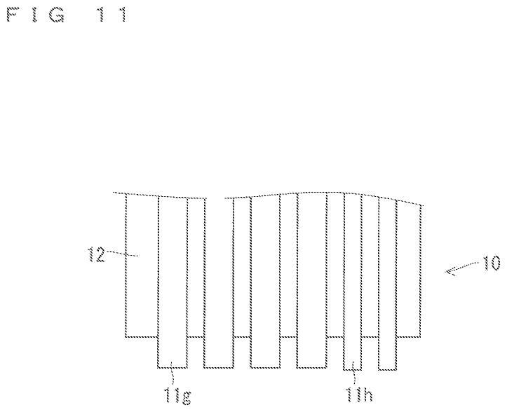

The plurality of wire-like transmission members 11 having a common feature may be sequentially arranged in parallel to each other in the flat wiring member 10. FIG. 11 is a schematic plan view illustrating an example that the plurality of wire-like transmission members 11 having a common feature are sequentially arranged in parallel to each other in the flat wiring member 10. The flat wiring member 10 illustrated in FIG. 11 includes the plural types of wire-like transmission members 11 each having a different size of diameter. For example, the flat wiring member 10 may include a plurality of wire-like transmission members 11g each having a large diameter and a plurality of wire-like transmission members 11h each having a small diameter. In this case, the plurality of wire-like transmission members 11g each having the large diameter are sequentially arranged in parallel to each other and the plurality of wire-like transmission members 11h each having the small diameter are sequentially arranged in parallel to each other. The flat wiring member 10 may include three or more types of wire-like transmission members 11 each having a different size of diameter.

When the plurality of wire-like transmission members 11 each having the same diameter are sequentially arranged in parallel to each other in the flat wiring member 10 as with the example in FIG. 11, the plurality of wire-like transmission members 11 can be simultaneously routed. Thus, the flat wiring member 10 can be manufactured easily.

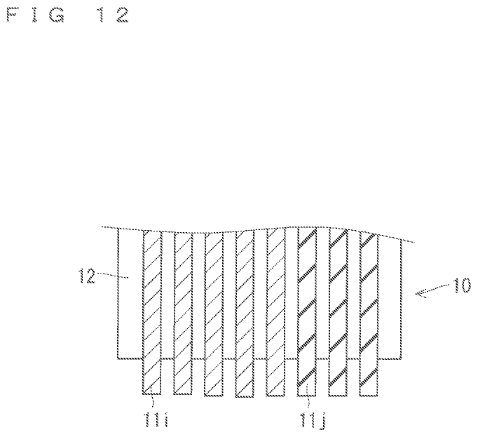

FIG. 12 is a schematic plan view illustrating the other example that the plurality of wire-like transmission members 11 having a common feature are sequentially arranged in parallel to each other in the flat wiring member 10. The flat wiring member 10 illustrated in FIG. 12 includes the plural types of wire-like transmission members 11 each having a color different from each other. In other words, the flat wiring member 10 includes the plural types of wire-like transmission members 11 in which an outer peripheral surface of an insulating covering has a color different from each other. For example, the flat wiring member 10 may include a plurality of black wire-like transmission members 11i and a plurality of red wire-like transmission members 11j. In this case, as illustrated in FIG. 12, the plurality of wire-like transmission members 11i are sequentially arranged in parallel to each other and the plurality of wire-like transmission members 11j are sequentially arranged in parallel to each other in the flat wiring member 10. The flat wiring member 10 may include the wire-like transmission member 11 indicating a color other than black and red. The flat wiring member 10 may include three or more types of wire-like transmission members 11 each having a color different from each other.

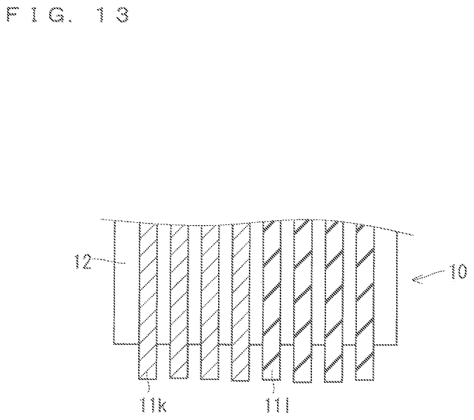

FIG. 13 is a schematic plan view illustrating the other example that the plurality of wire-like transmission members 11 having a common feature are sequentially arranged in parallel to each other in the flat wiring member 10. The flat wiring member 10 illustrated in FIG. 13 includes the plural types of wire-like transmission members 11 each having a type of core wire different from each other. For example, the flat wiring member 10 may include the plural types of wire-like transmission members 11 with core wires each made up a material different from each other. For example, the flat wiring member 10 may include a plurality of wire-like transmission members 11k whose core wires are made of aluminum and a plurality of wire-like transmission members 11l whose core wires are made of copper. In this case, the plurality of wire-like transmission members 11k are sequentially arranged in parallel to each other and the plurality of wire-like transmission members 11l are sequentially arranged in parallel to each other in the flat wiring member 10. The flat wiring member 10 may include the wire-like transmission member 11 whose core wire is made up of a material other than aluminum and copper.

The flat wiring member 10 may include the plural types of wire-like transmission members 11 with core wires each having a shape different from each other. For example, the flat wiring member 10 may include a plural types of wire-like transmission members 11k whose core wires are strands and a plurality of wire-like transmission members 11l whose core wires are single wires. The flat wiring member 10 may include the plural types of wire-like transmission members 11 each including metal constituting a core wire whose compression ratio is different from each other. For example, the flat wiring member 10 may include the plural types of wire-like transmission members 11k in which metal constituting a core wire has a large compression ratio and the plurality of wire-like transmission members 11l in which metal constituting a core wire has a small compression ratio. The flat wiring member 10 may include three or more types of wire-like transmission members 11 each having a type of core wire different from each other.

<Arrangement of Wire-Like Transmission Member in Bending Part of Flat Wiring Member>

When the flat wiring member 10 includes a bending part 100 where the plurality of wire-like transmission members 11 are bended, the wire-like transmission member 11 having a smallest diameter may be located on an innermost side in the bending part 100. The bending part 100 may include all of the plurality of wire-like transmission members 11 included in the flat wiring member 10 or only some of the plurality of wire-like transmission members 11.

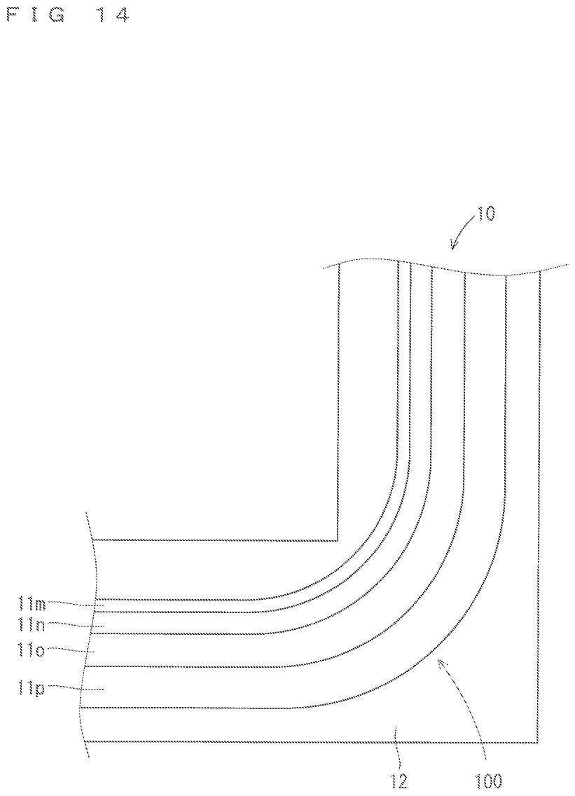

FIG. 14 is a schematic plan view illustrating an example of the bending part 100. In the example in FIG. 14, the bending part 100 of the flat wiring member 10 includes curved wire-like transmission members 11m, 11n, 11o, and 11p. Diameters of the wire-like transmission members 11m, 11n, 11o, and 11p increase in this order. The wire-like transmission member 11m having a smallest diameter is located on an innermost side in the bending part 100. The wire-like transmission members 11m, 11n, 11o, and 11p are disposed to be located on an outer side as a diameter thereof gets larger in the bending part 100. Thus, the wire-like transmission member 11p having a largest diameter is located on an outermost side.

In this manner, the wire-like transmission member 11m having the smallest diameter in the plurality of wire-like transmission members 11m, 11n, 11o, and 11p is located on the innermost side in the bending part 100. Accordingly, bending radii of the wire-like transmission members 11n, 11o, and 11p each having a larger outer diameter than the wire-like transmission member 11m can be increased. The bending radii of the wire-like transmission members 11n, 11o, and 11p each having the large diameter are increased, thus the wire-like transmission members 11n, 11o, and 11p each having the large diameter can be bended easily. Thus, the flat wiring member 10 having the bending part 100 can be manufactured easily.

When the plurality of wire-like transmission members 11m, 11n, 11o, and 11p are disposed to be located on the outer side as the diameter thereof gets larger in the bending part 100 as with the example in FIG. 14, the bending radius of the wire-like transmission member 11 can be increased as the diameter of the wire-like transmission member 11 gets larger in the bending part 100. Thus, the plurality of wire-like transmission members 11m, 11n, 11o, and 11p can be bended easily.

When the plurality of wire-like transmission members 11m, 11n, 11o, and 11p are disposed to be located on the outer side as the diameter thereof gets larger in the bending part 100, the plurality of wire-like transmission members 11m, 11n, 11o, and 11p can be disposed close to each other easily in the bending part 100 as illustrated in FIG. 14. Accordingly, a space occupied by the bending part 100 can be reduced. Thus, a space for routing the flat wiring member 10 can be reduced.

The bending part 100 of the flat wiring member 10 may include the plurality of wire-like transmission members 11 having the same diameter. For example, when the bending part 100 includes the plurality of wire-like transmission members 11m, the plurality of wire-like transmission members 11m are sequentially disposed in parallel to each other from the innermost side toward the outermost side. When the bending part 100 includes the plurality of wire-like transmission members 11p, the plurality of wire-like transmission members 11p are sequentially disposed in parallel to each other from the outermost side toward the innermost side.

An arrangement position, in the bending part 100, of the wire-like transmission member 11 other than the wire-like transmission member 11m having the smallest diameter in the plurality of wire-like transmission members 11m, 11n, 11o, 11p is not limited to that in the example in FIG. 14. For example, the wire-like transmission member 11o may be disposed on the outermost side of the bending part 100. The wire-like transmission member 11o may be disposed adjacent to the wire-like transmission member 11m.

When the stacking part 2 of the wiring member 1 includes a bending part 200 bending along the longitudinal direction of the wire-like transmission member 11, the flat wiring member 10 including the wire-like transmission member 11 having the smallest diameter may be disposed on the innermost side in the bending part 200.

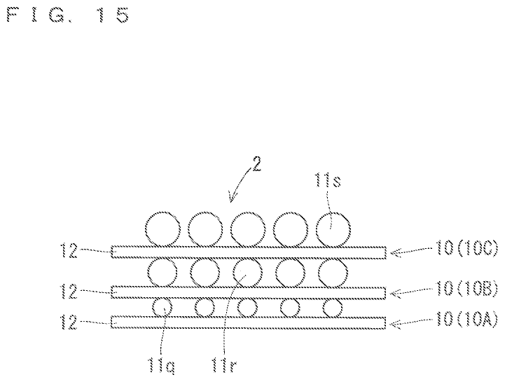

FIG. 15 is a schematic cross-sectional view illustrating an example of the stacking part 2 of the wiring member 1. In the example in FIG. 15, the flat wiring members 10A, 10B, and 10C include the plurality of wire-like transmission members 11 having the same diameter, respectively. The diameter of the wire-like transmission member 11 is different from each other between the flat wiring members 10A, 10B, and 10C. The flat wiring member 10A includes a wire-like transmission member 11q having a smallest diameter. The flat wiring member 10B includes a wire-like transmission member 11r having a second smallest diameter. The flat wiring member 10C includes a wire-like transmission member 11s having a largest diameter.

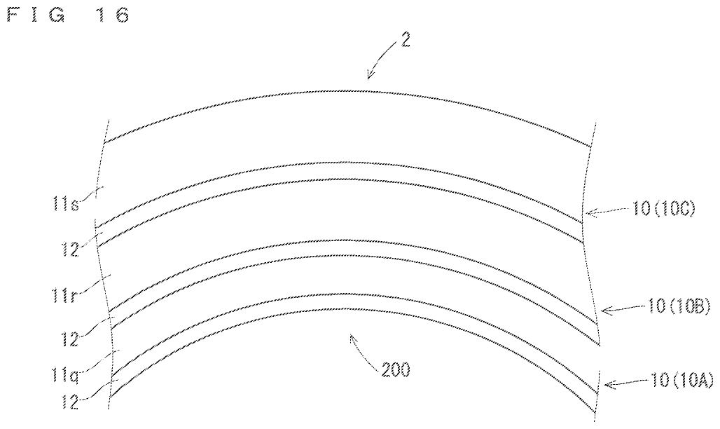

FIG. 16 is a schematic side view illustrating an example of the bending part 200 included in the stacking part 2 illustrated in FIG. 15. In the bending part 200 illustrated in FIG. 16, the flat wiring member 10A including the wire-like transmission member 11q having the smallest diameter is located on the innermost side. The flat wiring member 10B including the wire-like transmission member 11r having the second smallest diameter is located on a middle side in the bending part 200. The flat wiring member 10C including the wire-like transmission member 11s having the largest diameter is located on the outermost side in the bending part 200.

In this manner, the flat wiring member 10A including the wire-like transmission member 11q having the smallest diameter is located on the innermost side in the bending part 200. Accordingly, bending radii of the wire-like transmission members 11r and 11s each having a larger outer diameter than the wire-like transmission member 11q can be increased. The bending radii of the wire-like transmission members 11r and 11s each having the large diameter are increased, thus the wire-like transmission members 11r and 11s each having the large diameter can be bended easily. Thus, the wiring member 1 having the bending part 200 can be manufactured easily.

When the flat wiring member 10 is located on the outer side as the diameter of the wire-like transmission member 11 included in the flat wiring member 10 gets larger in the bending part 200 as with the example in FIG. 16, the bending radius of the wire-like transmission member 11 can be increased as the diameter of the wire-like transmission member 11 gets larger. Thus, the plurality of wire-like transmission members 11q, 11r, and 11s can be bended easily.

The bending part 200 may include the plurality of wire-like transmission members 10 including the wire-like transmission member 11 of the same diameter. For example, when the bending part 200 includes the plurality of flat wiring members 10A each including the wire-like transmission member 11q, the plurality of flat wiring members 10A are sequentially disposed from the innermost side toward the outermost side. When the bending part 200 includes the plurality of flat wiring members 10C each including the wire-like transmission member 11s, the plurality of flat wiring members 10C are sequentially disposed from the outermost side toward the innermost side.

An arrangement position, in the bending part 200, of the flat wiring member 10 other than the flat wiring member 10A including the wire-like transmission member 11q of the smallest diameter in the flat wiring members 10A, 10B, and 10B is not limited to that in the example in FIG. 16. For example, the flat wiring member 10B may be disposed on the outermost side of the bending part 200.

Although the wiring member 1 is described above in detail, the foregoing description is in all aspects illustrative and does not restrict the disclosure. The various modification examples described above can be appropriately combined and applied as long as they are not contradictory. It is therefore understood that numerous modification examples can be devised without departing from the scope of the invention.

### EXPLANATION OF REFERENCE SIGNS

1 wiring member
2 stacked part
10, 10A, 10B, 10C flat wiring member
11, 11a, 11b, 11c, 11d, 11e, 11f, 11g, 11h, 11i, 11j, 11k, 11l, 11m, 11n, 11o, 11p, 11q, 11r, 11s wire-like transmission member
12 sheet
13A, 13BB, 13C connector
13B ground terminal
20 boundary line
30, 30A, 30B, 30C, 231A, 231B, 231C connection target group
100, 200 bending part
130A power source box
130B metal body
130C controller
230A standard mounted component
230B, 230C optional component
500 roof
510 front area
520 center area
530 back area

1. A wiring member comprising a plurality of wire-like transmission members, wherein
the plurality of wire-like transmission members are grouped into at least a plurality of first wire-like transmission members and a plurality of second wire-like transmission members in accordance with a predetermined condition regarding the plurality of wire-like transmission members,
the wiring member comprises:
a first flat wiring member including the plurality of first wire-like transmission members; and
a second flat wiring member including the plurality of second wire-like transmission members, and
at least a part of the first flat wiring member and at least a part of the second flat wiring member are stacked.

2. The wiring member according to claim 1, wherein
the plurality of wire-like transmission members are grouped into at least the plurality of first wire-like transmission members and the plurality of second wire-like transmission members in accordance with a connection destination of the plurality of wire-like transmission members.

3. The wiring member according to claim 1, wherein
the plurality of wire-like transmission members are grouped into at least the plurality of first wire-like transmission members and the plurality of second wire-like transmission members in accordance with a type of the plurality of wire-like transmission members.

4. The wiring member according to claim 2, wherein
the plurality of first wire-like transmission members include a power source line or a ground line, and
the plurality of second wire-like transmission members include a signal line.

5. The wiring member according to claim 2, wherein
the plurality of first wire-like transmission members are connected to at least one standard mounted component of a vehicle, and
the plurality of second wire-like transmission members are connected to at least one optional component of the vehicle.

6. The wiring member according to claim 2, wherein
the plurality of first wire-like transmission members are connected to at least one first connection target part located in a first area, and
the plurality of second wire-like transmission members are connected to at least one second connection target part located in a second area different from the first area.

7. The wiring member according to claim 1, wherein
the plurality of first wire-like transmission members include at least one wire-like transmission member indicating a color capable of distinguishing the first flat wiring member and the second flat wiring member.

8. The wiring member according to claim 7, wherein
the plurality of first wire-like transmission members include at least one wire-like transmission member indicating a color different from a color of at least one of the plurality of second wire-like transmission members.

9. The wiring member according to claim 8, wherein
the plurality of first wire-like transmission members include at least one wire-like transmission member indicating a color different from a color of each of the plurality of second wire-like transmission members.

10. The wiring member according to claim 1, wherein
the first flat wiring member includes a bending part where a plurality of third wire-like transmission members included in the plurality of first wire-like transmission members are bended, and
a third wire-like transmission member with a smallest diameter in the plurality of third wire-like transmission members is located on an innermost side of the bending part.

11. The wiring member according to claim 10, wherein
the plurality of third wire-like transmission members are disposed to be located to an outer side as a diameter of each of the plurality of third wire-like transmission members gets larger in the bending part.
